(19) United States
(12) Patent Application Publication
(10) Pub. No.: US 2026/0162584 A1
(43) Pub. Date: Jun. 11, 2026

(54) GATE DRIVE CIRCUIT AND DISPLAY PANEL

(71) Applicant: Everdisplay Optronics (Shanghai) Co., Ltd., Shanghai (CN)

(72) Inventors: Ying-Hsiang TSENG, Shanghai (CN); Lina XIAO, Shanghai (CN); Qi WANG, Shanghai (CN)

(73) Assignee: Everdisplay Optronics (Shanghai) Co., Ltd., Shanghai (CN)

(21) Appl. No.: 18/708,613

(22) PCT Filed: Sep. 13, 2023
(86) PCT No.: PCT/CN2023/118504

§ 371 Date: May 9, 2024

(30) Foreign Application Priority Data
Jul. 28, 2023 (CN) 202310947569.8

(51) Int. Cl. G09G 3/20; G09G 3/32

(52) U.S. Cl. CPC G09G 3/2092; G09G 3/32; G09G 2310/0267; G09G 2310/0286; G09G 2310/06

(57) ABSTRACT

The present disclosure relates to the field of display panels, and provides a gate drive circuit and a display panel. The gate drive circuit includes a plurality of stages of shift register units and a timing controller. Each stage of the shift register unit includes 12 or 13 transistors and 3 capacitors. The timing controller includes three timing control signal lines.

### CROSS REFERENCE TO RELATED APPLICATION

The present application is a U.S. National Stage of International Application No. PCT/CN 2023/118504, filed on Sep. 13, 2023, which claims the benefit of priority to Chinese Application No. 202310947569.8, filed on Jul. 28, 2023, both of which are incorporated by reference herein in their entireties for all purposes.

### TECHNICAL FIELD

The present disclosure relates to the field of bezel design of display panels, and specifically, to a gate drive circuit and a display panel.

### BACKGROUND

The display panel includes a plurality of pixel circuits distributed in an array in the display area and a gate drive circuit located in the edge area. The gate drive circuit includes a plurality of stages of shift register units. The gate drive circuit is used to provide corresponding scan driving signals for corresponding pixel circuits. Since the gate drive circuit is arranged in the edge area of the display panel, the number of components of the shift register and the arrangement of the gate drive circuit determine the bezel width of the display panel.

It should be noted that the information disclosed in the above background section is only used to enhance understanding of the background of the present disclosure, and therefore may include information that does not constitute prior art known to those of ordinary skill in the art.

### SUMMARY

In view of this, the present disclosure provides a gate drive circuit and a display panel.

One aspect of the present disclosure provides a gate drive circuit, including a plurality of stages of shift register units, wherein each shift register unit includes a control module, a reset module and an output setting module;

wherein the control module includes:

a third transistor, including a first electrode connected to a first power supply, a second electrode connected to a third node, and a gate electrode connected to a first timing control terminal;

a fourth transistor, including a first electrode connected to the third node, a second electrode connected to a second timing control terminal, and a gate electrode connected to a fourth node;

a fifth transistor, including a first electrode connected to a third timing control terminal, a second electrode connected to a first node, and a gate electrode connected to the third node;

an eleventh transistor, including a first electrode connected to the first power supply, a second electrode connected to the third node, and a gate electrode connected to a third timing control terminal;

wherein the reset module includes:

a second transistor, including a first electrode connected to the first power supply, a second electrode connected to the fourth node, and a gate electrode connected to the first timing control terminal;

a tenth transistor, including a first electrode connected to the first node, a second electrode connected to a second power supply, and a gate electrode connected to the third timing control terminal;

a twelfth transistor, including a first electrode connected to the third timing control terminal, a second electrode connected to the first node, and a gate electrode connected to the fourth node;

wherein the output setting module includes:

a first transistor, including a first electrode connected to the fourth node, a second electrode connected to a signal input terminal, and a gate electrode connected to the third timing control terminal;

a seventh transistor, including a first electrode connected to the first power supply, a second electrode connected to a signal output terminal, and a gate electrode connected to the first node;

an eighth transistor, including a first electrode connected to the signal output terminal, a second electrode connected to the second timing control terminal, and a gate electrode connected to the second node;

a ninth transistor, including a first electrode connected to the fourth node, a second electrode connected to the second node, and a gate electrode connected to the second power supply;

wherein the shift register unit further includes:

a first capacitor, including a first electrode connected to the first power supply, and a second electrode connected to the first node;

a second capacitor, including a first electrode connected to the second node, and a second electrode connected to the signal output terminal;

a third capacitor, including a first electrode connected to the first power supply, and a second electrode connected to the third node.

In some embodiments, the reset module further includes:
a sixth transistor, including a first electrode connected to the first node, a second electrode connected to the second power supply, and a gate electrode connected to the first timing control terminal.

In some embodiments, the reset module further includes:
a sixth transistor, including a second electrode connected to the second node, and a gate electrode connected to the first node;
a thirteenth transistor, including a first electrode connected to the first power supply, a second electrode connected to a first electrode of the sixth transistor, and a gate electrode connected to the second timing control terminal.

In some embodiments, the gate drive circuit further includes a timing controller, wherein the timing controller includes a first timing control signal line, a second timing control signal line and a third timing control signal line.

In some embodiments, the first timing control signal line is configured to output a first timing control signal, the second timing control signal line is configured to output a second timing control signal, and the third timing control signal line is configured to output a third timing control signal.

In some embodiments, the shift register unit is configured to conduct delay processing on a signal received from the signal input terminal under control of the first timing control signal, the second timing control signal and the third timing control signal, and the processed signal is output by the signal output terminal.

In some embodiments, the shift register unit of a previous stage outputs a scan signal to the shift register unit of a next stage, and the shift register unit of a last stage outputs a scan signal.

In some embodiments, in a (3N−2)-th stage shift register unit, the first timing control terminal is connected to the first timing control signal line, the second timing control terminal is connected to the second timing control signal line, and the third timing control terminal is connected to the third timing control signal line, where N is a positive integer.

In some embodiments, in a (3N−1)-th stage shift register unit, the first timing control terminal is connected to the third timing control signal line, the second timing control terminal is connected to the first timing control signal line, and the third timing control terminal is connected to the second timing control signal line, where N is a positive integer.

In some embodiments, in a 3N-th stage shift register unit, the first timing control terminal is connected to the second timing control signal line, the second timing control terminal is connected to the third timing control signal line, and the third timing control terminal is connected to the first timing control signal line, where N is a positive integer.

In some embodiments, the first to thirteenth transistors are all P-type MOS transistors.

Another aspect of the present disclosure further provides a display panel, including any one of the above gate drive circuits.

It should be understood that the above general description and the following detailed description are exemplary and explanatory only, and do not limit the present disclosures.

### BRIEF DESCRIPTION OF THE DRAWINGS

The accompanying drawings, which are incorporated in and constitute a part of this specification, illustrate embodiments consistent with the disclosure and together with the description serve to explain the principles of the disclosure. Apparently, the drawings in the following description are only some embodiments of the present disclosure. For those of ordinary skill in the art, other drawings can be obtained based on these drawings without exerting creative efforts.

FIG. 1 shows a schematic diagram of the display panel of the present disclosure;

FIG. 2 shows a cascade schematic diagram of the gate drive circuit of the present disclosure;

FIG. 3 shows a circuit diagram of a shift register unit according to a first embodiment of the present disclosure;

FIG. 4 shows a waveform diagram when the shift register unit shown in FIG. 3 is operating;

FIG. 5 shows a schematic diagram of the conduction state of the shift register unit in stage t11 in FIG. 4;

FIG. 6 shows a schematic diagram of the conduction state of the shift register unit in stage t12 in FIG. 4;

FIG. 7 shows a schematic diagram of the conduction state of the shift register unit in stage t13 in FIG. 4;

FIG. 8 shows a schematic diagram of the conduction state of the shift register unit in stage t14 in FIG. 4;

FIG. 9 shows a schematic diagram of the conduction state of the shift register unit in stage t15 in FIG. 4;

FIG. 10 shows a circuit diagram of a shift register unit according to a second embodiment of the present disclosure;

FIG. 11 shows a waveform diagram when the shift register unit shown in FIG. 10 is operating;

FIG. 12 shows a schematic diagram of the conduction state of the shift register unit in stage t21 in FIG. 11;

FIG. 13 shows a schematic diagram of the conduction state of the shift register unit in stage t22 in FIG. 11;

FIG. 14 shows a schematic diagram of the conduction state of the shift register unit in stage t23 in FIG. 11;

FIG. 15 shows a schematic diagram of the conduction state of the shift register unit in stage t24 in FIG. 11;

FIG. 16 shows a schematic diagram of the conduction state of the shift register unit in stage t25 in FIG. 11.

### REFERENCE NUMERALS

10 display panel
11 display area
20 timing controller
30 gate drive circuit
CKV1 first timing control signal line
CKV2 second timing control signal line
CKV3 third timing control signal line
c1 first timing control terminal
c2 second timing control terminal
c3 third timing control terminal
IN signal input terminal
Gout signal output terminal
T1 first transistor
T2 second transistor
T3 third transistor
T4 fourth transistor
T5 fifth transistor
T6 sixth transistor
T7 seventh transistor
T8 eighth transistor
T9 ninth transistor
T10 tenth transistor
T11 eleventh transistor
T12 twelfth transistor
T13 thirteenth transistor
C1 first capacitor
C2 second capacitor
C3 third capacitor
VDD first power supply
VEE second power supply
N1 first node
N2 second node
N3 third node
N4 fourth node

### DETAILED DESCRIPTION

Example embodiments will now be described more fully with reference to the accompanying drawings. Example embodiments may, however, be embodied in various forms and should not be construed as limited to the embodiments set forth herein. Rather, these embodiments are provided so that the present disclosure will be thorough and complete, and will fully convey the concept of example embodiments to those skilled in the art. The same reference numerals in the drawings represent the same or similar structures, and thus their repeated description will be omitted.

The use of “first”, “second” and similar words in specific descriptions does not imply any order, quantity or importance, but is only used to distinguish different components. In addition, in the description of the present disclosure, the orientation or positional relationship indicated by the terms “upper”, “lower”, etc. is based on the orientation or positional relationship shown in the drawings. It is only for convenience of description and does not indicate or imply that the devices or elements must have a specific orientation, and be constructed and operated in a specific orientation, and therefore are not to be construed as limitations of the present disclosure.

It should be noted that, as long as there is no conflict, embodiments of the present disclosure, and features in different embodiments can be combined with each other.

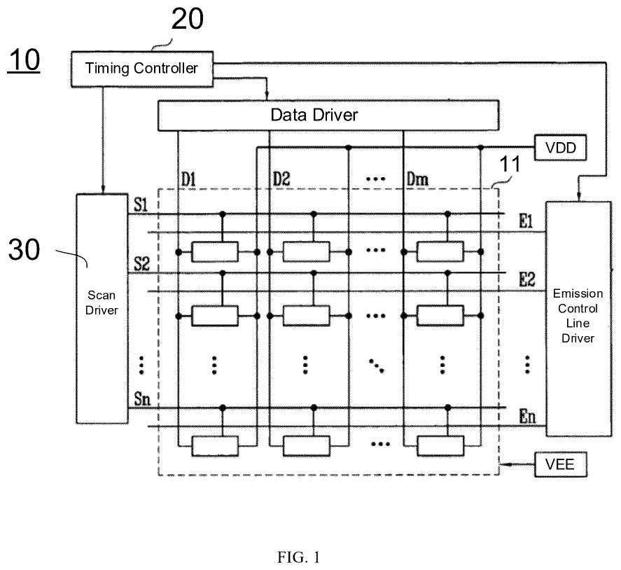

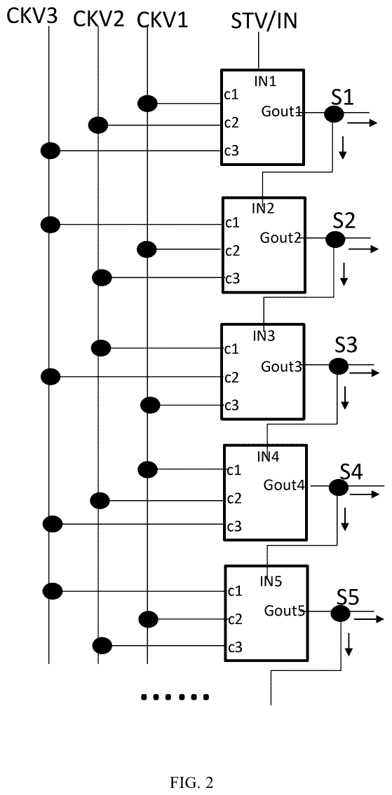

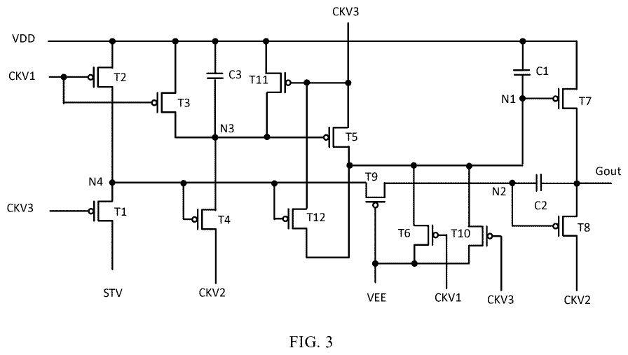

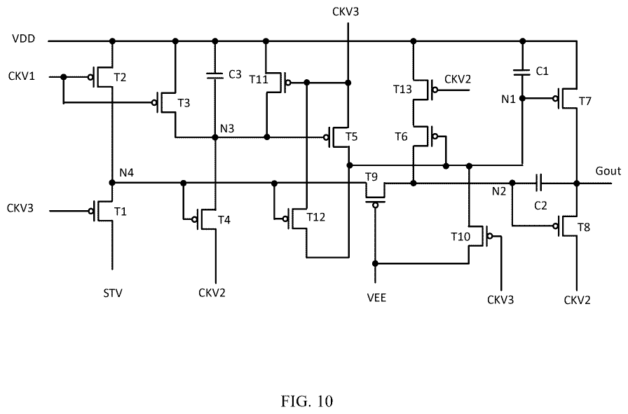

The inventor of this application provided a solution to the problems existing in the related art through detailed and in-depth research. As shown in FIGS. 1, 2, 3 and 10, FIG. 1 shows a schematic diagram of the display panel of the present disclosure, FIG. 2 shows a schematic diagram of the gate drive circuit of the present disclosure, FIG. 3 shows a circuit diagram of a shift register unit according to a first embodiment of the present disclosure, and FIG. 10 shows a circuit diagram of a shift register unit according to a second embodiment of the present disclosure. The embodiment of the present disclosure discloses a gate drive circuit 30 and a display panel 10. The gate drive circuit 30 includes a plurality of stages of shift register units and a timing controller. Each stage of the shift register unit includes 12 or 13 transistors, three capacitors, a signal input terminal IN, a signal output terminal Gout and three timing control terminals. The timing controller 20 includes three timing control signal lines. The gate drive circuit and display panel of the present disclosure use a new 12T3C or 13T3C shift register unit circuit, which improves the output stability of the shift register unit and reduces the number of components of the shift register unit, thereby reducing the bezel width of the display panel.

The specific embodiments of the present disclosure will be described in further detail below with reference to the accompanying drawings.

As shown in FIG. 1, one aspect of the present disclosure provides a display panel 10. The display panel 10 includes a display area 11 and a non-display area. The gate drive circuit 30, the data driver and the light-emitting control circuit are located in the non-display area of the display panel 10. The display area 11 includes light-emitting pixels arranged in an array and a pixel circuit. The light-emitting pixel emits light under the joint action of the gate drive circuit 30, the data driver, the light-emitting control circuit and the pixel circuit.

As shown in FIGS. 1 and 2, the present disclosure also provides a gate drive circuit 30, which includes a plurality of stages of shift register units and a timing controller 20.

In some embodiments, the shift register unit includes a control module, a reset module and an output setting module. Specifically, the shift register unit includes 12 or 13transistors, 3 capacitors, a signal input terminal IN, a signal output terminal Gout, a first timing control terminal c1, a second timing control terminal c2 and a third timing control terminal c3. Each stage of the shift register unit outputs a scan signal. The scan signal is input to a row of pixel circuits in the display area 11 of the display panel 10, to drive the row of pixels to emit light. The shift register unit of the previous stage simultaneously outputs the scan signal to the signal input terminal IN of the shift register unit of the next stage as a start signal. The shift register unit of the last stage outputs a scan signal that is only input to that row of the pixel circuit, because there is no next stage.

Specifically, in FIG. 2, five cascaded shift register units are shown as an example. The start pulse signal STV is input to the signal input terminal IN1 of the first-stage shift register unit S1 as the input signal. The signal output terminal Gout1 of the first-stage shift register unit S1 outputs the scan signal as the input signal of the second-stage shift register unit S2. The signal output terminal Gout1 of the first-stage shift register unit S1 is connected to the signal input terminal IN2 of the second-stage shift register unit S2. The signal output terminal Gout2 of the second-stage shift register unit S2 outputs the scan signal as the input signal of the third-stage shift register unit S3. The signal output terminal Gout2 of the second-stage shift register unit S2 is connected to the signal input terminal IN3 of the third-stage shift register unit S3. The signal output terminal Gout3 of the third-stage shift register unit S3 outputs the scan signal as the input signal of the fourth-stage shift register unit S4. The signal output terminal Gout3 of the third-stage shift register unit S3 is connected to the signal input terminal IN4 of the fourth-stage shift register unit S4. The signal output terminal Gout4 of the fourth-stage shift register unit S4 outputs the scan signal as the input signal of the fifth-stage shift register unit S5. The signal output terminal Gout4 of the fourth-stage shift register unit S4 is connected to the signal input terminal IN5 of the fifth-stage shift register unit S5. The shift register units of subsequent stages repeat this to form the gate drive circuit 30.

In some embodiments, as shown in FIG. 2, the timing controller 20 includes a first timing control signal line CKV1, a second timing control signal line CKV2 and a third timing control signal line CKV3. The first timing control signal line CKV1 is configured to output a first timing control signal. The second timing control signal line CKV2 is configured to output a second timing control signal. The third timing control signal line CKV3 is configured to output a third timing control signal. The first timing control signal, the second timing control signal and the third timing control signal are square wave signals with the same output frequency and successively continuous repeated low potential.

In some preferable embodiments, continuing to refer to FIG. 2, further, in the (3N−2)-th stage shift register unit, the first timing control terminal c1 is connected to the first timing control signal line CKV1, for receiving the first timing control signal. The second timing control terminal c2 is connected to the second timing control signal line CKV2, for receiving the second timing control signal. The third timing control terminal c3 is connected to the third timing control signal line CKV3, for receiving the third timing control signal. N is a positive integer. In the (3N−1)-th stage shift register unit, the first timing control terminal c1 is connected to the third timing control signal line CKV3, for receiving the third timing control signal. The second timing control terminal c2 is connected to the first timing control signal line CKV1, for receiving the first timing control signal. The third timing control terminal c3 is connected to the second timing control signal line CKV2, for receiving the second timing control signal. N is a positive integer. In the 3N-th stage shift register unit, the first timing control terminal c1 is connected to the second timing control signal line CKV2, for receiving the second timing control signal. The second timing control terminal c2 is connected to the third timing control signal line CKV3, for receiving the third timing control signal. The third timing control terminal c3 is connected to the first timing control signal line CKV1, for receiving the first timing control signal. N is a positive integer. Each stage of the shift register unit of the gate drive circuit 30 receives three types of timing control signals according to the above rules.

In some embodiments, the shift register unit is configured to conduct delay processing on a signal received from the signal input terminal IN under control of the first timing control signal, the second timing control signal and the third timing control signal, and the processed signal is output by the signal output terminal Gout. The signal is output to the display area 11 as a scanning signal or input to the signal input terminal IN of the next stage shift register unit.

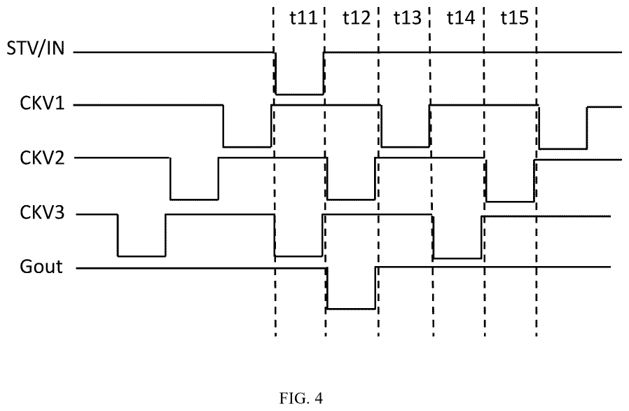

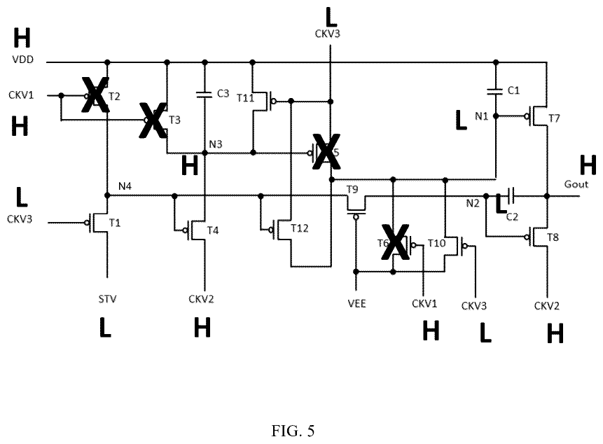

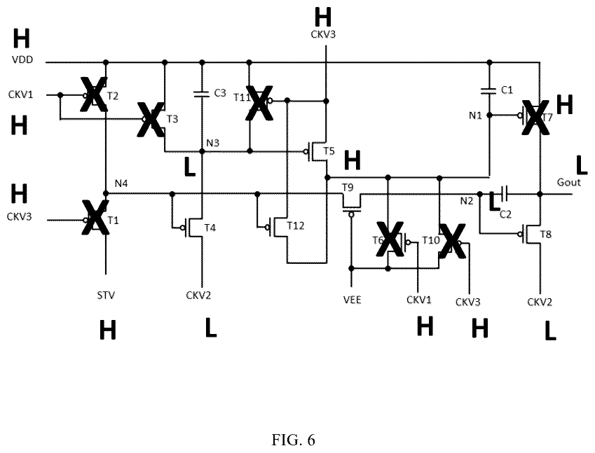

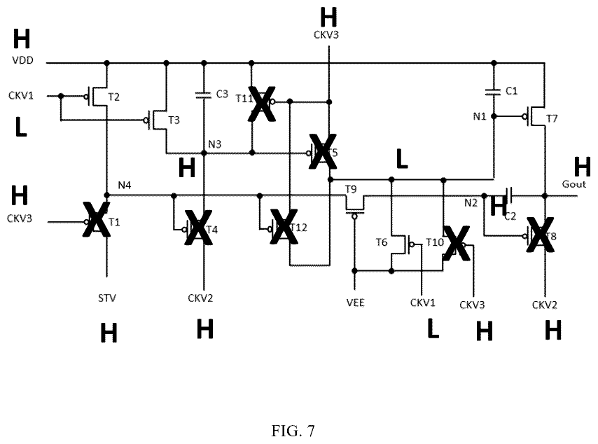

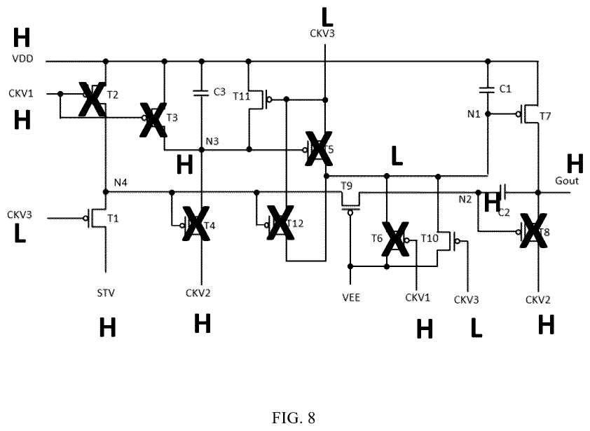

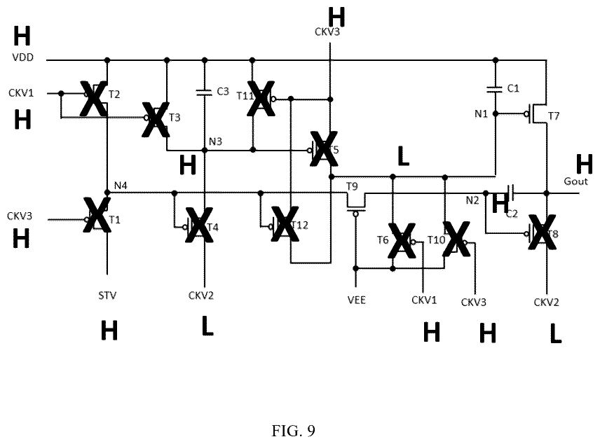

FIGS. 1 to 9 show the first embodiment of the present disclosure, where FIG. 4 shows a waveform diagram when the shift register unit shown in FIG. 3 is operating, FIG. 5 shows a schematic diagram of the conduction state of the shift register unit in stage t11 in FIG. 4, FIG. 6 shows a schematic diagram of the conduction state of the shift register unit in stage t12 in FIG. 4, FIG. 7 shows a schematic diagram of the conduction state of the shift register unit in stage t13 in FIG. 4, FIG. 8 shows a schematic diagram of the conduction state of the shift register unit in stage t14 in FIG. 4, and FIG. 9 shows a schematic diagram of the conduction state of the shift register unit in stage t15 in FIG. 4.

As shown in FIG. 3, the shift register unit of the first embodiment of the present disclosure includes a control module, a reset module and an output setting module. Specifically, the shift register unit includes 12 transistors, 3 capacitors, a signal input terminal IN, a signal output terminal Gout, a first timing control terminal c1, a second timing control terminal c2, and a third timing control terminal c3.

In this embodiment, as shown in FIG. 3, the control module includes: a third transistor T3, a fourth transistor T4, a fifth transistor T5, and an eleventh transistor T11. The first electrode of the third transistor T3 is connected to the first power supply VDD, the second electrode of the third transistor T3 is connected to the third node N3, and the gate electrode of the third transistor T3 is connected to the first timing control terminal c1. The first electrode of the fourth transistor T4 is connected to the third node N3, a second electrode of the fourth transistor T4 is connected to the second timing control terminal c2, and a gate electrode of the fourth transistor T4 is connected to the fourth node N4. The first electrode of the fifth transistor T5 is connected to the third timing control terminal c3, the second electrode of the fifth transistor T5 is connected to the first node N1, and the gate electrode of the fifth transistor T5 is connected to the third node N3. The first electrode of the eleventh transistor T11 is connected to the first power supply VDD, the second electrode of the eleventh transistor T11 is connected to the third node N3, and the gate electrode of the eleventh transistor T11 is connected to the third timing control terminal c3.

In this embodiment, as shown in FIG. 3, the reset module includes: a second transistor T2, a tenth transistor T10, and a twelfth transistor T12. The first electrode of the second transistor T2 is connected to the first power supply VDD, the second electrode of the second transistor T2 is connected to the fourth node N4, and the gate electrode of the second transistor T2 is connected to the first timing control terminal c1. The first electrode of the tenth transistor T10 is connected to the first node N1, the second electrode of the tenth transistor T10 is connected to the second power supply VEE, and the gate electrode of the tenth transistor T10 is connected to the third timing control terminal c3. The first electrode of the twelfth transistor T12 is connected to the third timing control terminal c3, the second electrode of the twelfth transistor T12 is connected to the first node N1, and the gate electrode of the twelfth transistor T12 is connected to the fourth node N4. Specifically, the reset module further includes a sixth transistor T6. The first electrode of the sixth transistor T6 is connected to the first node N1, the second electrode of the sixth transistor T6 is connected to the second power supply VEE, and the gate electrode of the sixth transistor T6 is connected to the first timing control terminal c1.

In this embodiment, as shown in FIG. 3, the output setting module includes: a first transistor T1, a seventh transistor T7, an eighth transistor T8, and a ninth transistor T9. The first electrode of the first transistor T1 is connected to the fourth node N4, a second electrode of the first transistor T1 is connected to the signal input terminal IN, and a gate electrode of the first transistor T1 is connected to the third timing control terminal c3. The first electrode of the seventh transistor T7 is connected to the first power supply VDD, the second electrode of the seventh transistor T7 is connected to the signal output terminal Gout, and the gate electrode of the seventh transistor T7 is connected to the first node N1. The first electrode of the eighth transistor T8 is connected to the signal output terminal Gout, the second electrode of the eighth transistor T8 is connected to the second timing control terminal c2, and the gate electrode of the eighth transistor T8 is connected to the second node N2. The first electrode of the ninth transistor T9 is connected to the fourth node N4, the second electrode of the ninth transistor T9 is connected to the second node N2, and the gate electrode of the ninth transistor T9 is connected to the second power supply VEE.

In this embodiment, as shown in FIG. 3, the shift register unit further includes:
a first capacitor C1, a second capacitor C2, and a third capacitor C3. The first electrode of the first capacitor C1 is connected to the first power supply VDD, and the second electrode of the first capacitor C1 is connected to the first node N1. The first electrode of the second capacitor C2 is connected to the second node N2, and the second electrode of the second capacitor C2 is connected to the signal output terminal Gout. The first electrode of the third capacitor C3 is connected to the first power supply VDD, and the second electrode of the third capacitor C3 is connected to the third node N3. The first power supply VDD provides a positive voltage signal, and the second power supply VEE provides a negative voltage signal.

In this embodiment, the first transistor M1 to the twelfth transistor M12 are all P-type MOS transistors. The control terminal of the PMOS transistor is a gate electrode, the first electrode of the PMOS transistor is a source electrode, and the second electrode of the PMOS transistor is a drain electrode, or the first electrode is a drain electrode and the second electrode is a source electrode. The turn-on level of the PMOS transistor is a low level, and the turn-off level of the PMOS transistor is a high level. In some other embodiments, those skilled in the art can easily conclude that the shift register unit provided by the present disclosure can be easily changed to all N-type MOS transistors. Alternatively, the shift register unit provided by the present disclosure can also be easily changed to a CMOS transistor or the like.

In this embodiment, referring to FIG. 4, the waveform diagram shown in FIG. 4 includes five processes: t11, t12, t13, t14 and t15. During these five processes, the output signal of the signal output terminal Gout of the above-mentioned shift register unit completes a process from setting to resetting. It should be noted that, for convenience of understanding, the high-level signal is represented by “H”, and the low-level signal is represented by “L” in the drawings. The relationship between the input and output of the shift register unit in the above five processes is analyzed below based on the waveform diagram in FIG. 4 and the circuit diagram in FIG. 3.

In this embodiment, referring to FIGS. 4 and 5, during the t11 process, the signal input terminal IN inputs a low level, the first timing control signal line CKV1 inputs a high level, the second timing control signal line CKV2 inputs a high level, and the third timing control signal line CKV3 inputs a low level. At this time, the first transistor T1, the fourth transistor T4, the seventh transistor T7, the eighth transistor T8, the ninth transistor T9, the tenth transistor T10, the eleventh transistor T11 and the twelfth transistor T12 are turned on, and the second transistor T2, the third transistor T3, the fifth transistor T5 and the sixth transistor T6 are turned off. Specifically, the first transistor T1 and the tenth transistor T10 are turned on due to the low potential of the third timing control signal line CKV3. The low potentials of the signal input terminal IN and the second power supply VEE are respectively written into the second node N2 and the first node N1, at the same time, the fourth transistor T4 and the twelfth transistor T12 are turned on due to the low potential of the second node N2. The low potential of the third timing control signal line CKV3 is written into the first node N1, and the high potential is written into the third node N3 due to turn-on of the fourth transistor T4, the fifth transistor T5 is turned off. The first node N1 and the second node N2 are at a low potential, so that both the seventh transistor T7 and the eighth transistor T8 are turned on. Finally, the signal output terminal Gout outputs the high potential of the first power supply VDD and the second timing control signal line CKV2.

In this embodiment, referring to FIGS. 4 and 6, during the t12 process, the signal input terminal IN inputs a high level, the first timing control signal line CKV1 inputs a high level, the second timing control signal line CKV2 inputs a low level, and the third timing control signal line CKV3 inputs a high level. At this time, the fourth transistor T4, the fifth transistor T5, the eighth transistor T8, the ninth transistor T9, and the twelfth transistor T12 are turned on, and the first transistor T1, the second transistor T2, the third transistor T3, the sixth transistor T6, the seventh transistor T7, the tenth transistor T10 and the eleventh transistor T11 are turned off. Specifically, the first transistor T1 is turned off due to the high level of the third timing control signal line CKV3. The second node N2 maintains the low level at the previous moment, the eighth transistor T8 remains turned on, the fourth transistor T4 and the twelfth transistor T12 remain turned on due to the low potential of the second node N2. The low potential of the second timing control signal line CKV2 is written into the third node N3, the fifth transistor T5 is turned on. A high potential is written into the first node N1 simultaneously by the fifth transistor T5 and the twelfth transistor T12, the seventh transistor T7 is turned off. Finally, the signal output terminal Gout outputs the low potential of the second timing control signal line CKV2.

In this embodiment, referring to FIGS. 4 and 7, during the t13 process, the signal input terminal IN inputs a high level, the first timing control signal line CKV1 inputs a low level, the second timing control signal line CKV2 inputs a high level, and the third timing control signal line CKV3 inputs a high level. At this time, the second transistor T2, the third transistor T3, the sixth transistor T6, the seventh transistor T7, and the ninth transistor T9 are turned on, and the first transistor T1, the fourth transistor T4, the fifth transistor T5, the eighth transistor T8, the tenth transistor T10, the eleventh transistor T11 and the twelfth transistor T12 are turned off. Specifically, the second transistor T2, the third transistor T3 and the sixth transistor T6 are turned on due to the low potential of the first timing control signal line CKV1. A high potential is written into the second node N2 due to turn-on of the second transistor T2, the fourth transistor T4, the eighth transistor T8 and the twelfth transistor T12 are turned off. The high potential of the first power supply VDD is written into the third node N3 due to turn-on of the third transistor T3, the fifth transistor T5 is turned off. The low potential of the second power supply VEE is written into the first node N1 due to turn-on of the sixth transistor T6, the seventh transistor T7 is turned on. Finally, the signal output terminal Gout outputs the high potential of the first power supply VDD.

In this embodiment, referring to FIGS. 4 and 8, during the t14 process, the signal input terminal IN inputs a high level, the first timing control signal line CKV1 inputs a high level, the second timing control signal line CKV2 inputs a high level, and the third timing control signal line CKV3 inputs a low level. At this time, the first transistor T1, the seventh transistor T7, the ninth transistor T9, the tenth transistor T10, and the eleventh transistor T11 are turned on, and the second transistor T2, the third transistor T3, the fourth transistor T4, and the fifth transistor T5, the sixth transistor T6, the eighth transistor T8 and the twelfth transistor T12 are turned off. Specifically, the first transistor T1, the tenth transistor T10 and the eleventh transistor T11 are turned on due to the low potential of the third timing control signal line CKV3. The high potential of the signal input terminal IN is written into the second node N2, the fourth transistor T4, the eighth transistor T8 and the twelfth transistor T12 remain turned off. The high potential of the first power supply VDD is written into the third node N3 due to turn-on of the eleventh transistor T11, the fifth transistor T5 remains turned off. The low potential of the second power supply VEE is written into the first node N11 due to turn-on of the tenth transistor T10, the seventh transistor T7 remains turned on. Finally, the signal output terminal Gout outputs the high potential of the first power supply VDD.

In this embodiment, referring to FIGS. 4 and 9, during the t15 process, the signal input terminal IN inputs a high level, the first timing control signal line CKV1 inputs a high level, the second timing control signal line CKV2 inputs a low level, and the third timing control signal line CKV3 inputs a high level. At this time, the seventh transistor T7 and the ninth transistor T9 are turned on, and the first transistor T1, the second transistor T2, the third transistor T3, the fourth transistor T4, the fifth transistor T5, the sixth transistor T6, the eighth transistor T8, the tenth transistor T10, the eleventh transistor T11 and the twelfth transistor T12 are turned off. Specifically, the first transistor T1, the tenth transistor T10 and the eleventh transistor T11 are turned off due to the high potential of the third timing control signal line CKV3. The third node N3 maintains the high potential at the previous moment, the fifth transistor T5 is turned off. The second node N2 maintains the high potential at the previous moment, the eighth transistor T8 is turned off. The first node N1 maintains the low potential at the previous moment, the seventh transistor T7 remains turned on. Finally, the signal output terminal Gout outputs the high potential of the first power supply VDD.

The operation steps of the shift register unit after t15 repeat the t13 process to the t15 process until the next frame image begins to display, the start pulse signal STV or the signal input terminal IN inputs a low level, and re-enters the next round of the t11 process.

In this embodiment, the relationship between the input and output of the shift register unit is: if the start pulse signal STV or the signal input terminal IN is at a low level in a certain process, then under the action of the first timing control signal line CKV1, the second timing control signal line CKV2 and the third timing control signal line CKV3, the signal output terminal Gout also outputs a low level in the next process. In other processes, the start pulse signal STV or the signal input terminal IN and the signal output terminal Gout all remain at a high level, until the start pulse signal STV or the signal input terminal IN inputs a low level again, and the signal output terminal Gout outputs a low level again. It is equivalent to that the shift register unit conducts delay processing on the low-level signal from the start pulse signal STV or the signal input terminal IN and then output it from the signal output terminal Gout.

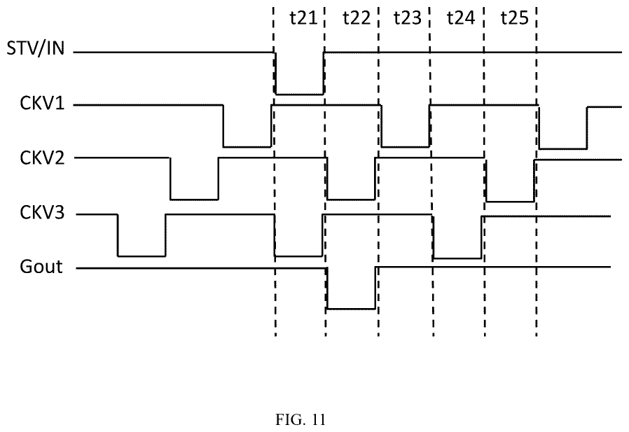

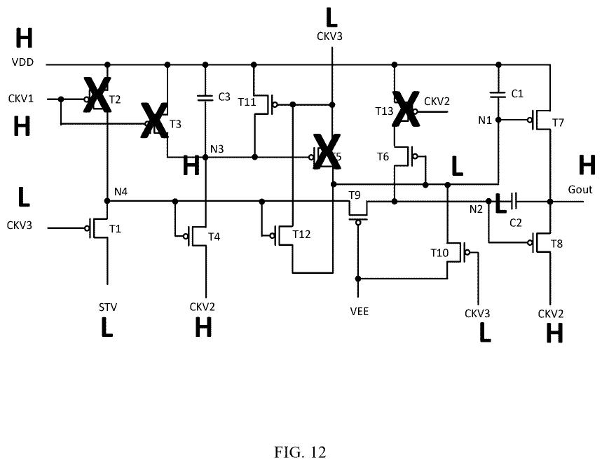

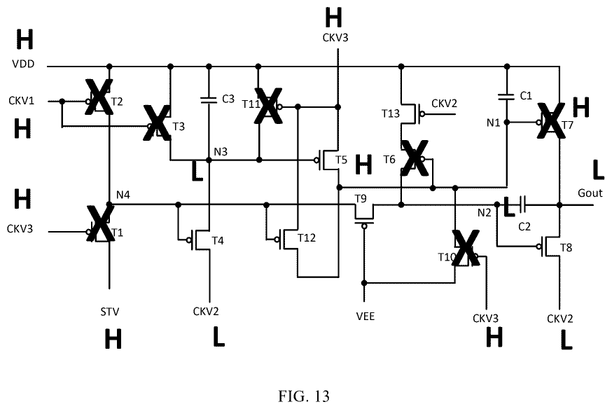

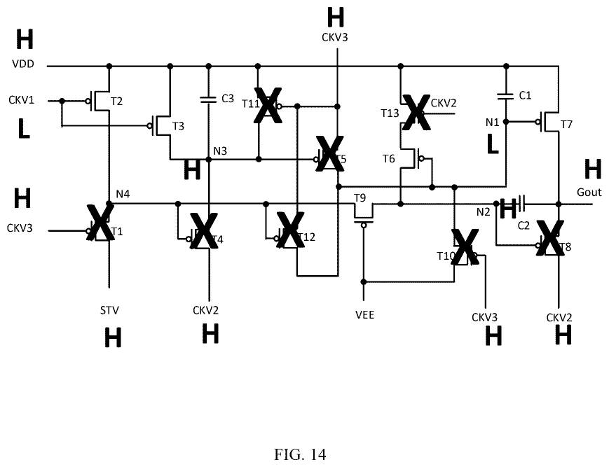

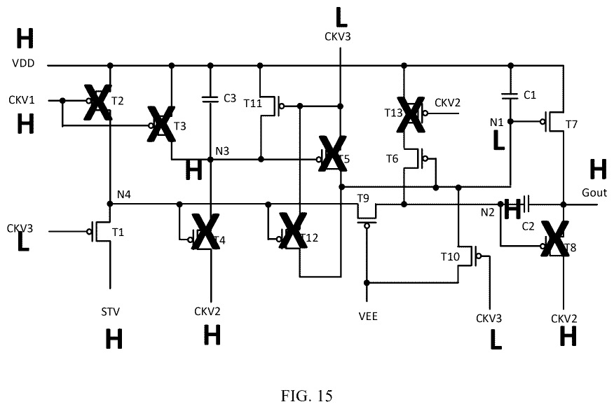

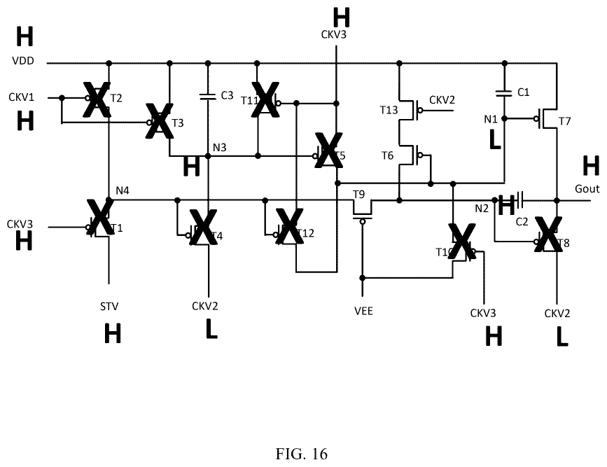

In the second embodiment of the present disclosure, with reference to FGIS. 1 to 2 and FIGS. 10 to 16, FIG. 11 shows a waveform diagram when the shift register unit shown in FIG. 10 is operating, FIG. 12 shows a schematic diagram of the conduction state of the shift register unit in stage t21 in FIG. 11, FIG. 13 shows a schematic diagram of the conduction state of the shift register unit in stage t22 in FIG. 11, FIG. 14 shows a schematic diagram of the conduction state of the shift register unit in stage t23 in FIG. 11, FIG. 15 shows a schematic diagram of the conduction state of the shift register unit in stage t24 in FIG. 11, and FIG. 16 shows a schematic diagram of the conduction state of the shift register unit in stage t25 in FIG. 11.

As shown in FIG. 3, the shift register unit of the second embodiment of the present disclosure includes a control module, a reset module and an output setting module. Specifically, the shift register unit includes 13 transistors, 3 capacitors, a signal input terminal IN, a signal output terminal Gout, a first timing control terminal c1, a second timing control terminal c2, and a third timing control terminal c3.

In this embodiment, as shown in FIG. 3, the setting and connection manner of transistors of the output setting module and the control module, and three capacitors are the same as those in the first embodiment, which will not be described again herein. The reset module of this embodiment includes: a second transistor T2, a tenth transistor T10, and a twelfth transistor T12, and the connection manner is also the same as that of the first embodiment, and will not be described again here. The reset module of this embodiment also includes: a sixth transistor T6 and a thirteenth transistor T13. The second electrode of the sixth transistor T6 is connected to the second node N2, and the gate electrode of the sixth transistor T6 is connected to the first node N1. The first electrode of the thirteenth transistor T13 is connected to the first power supply VDD, the second electrode of the thirteenth transistor T13 is connected to the first electrode of the sixth transistor T6, and the gate electrode of the thirteenth transistor T13 is connected to the second timing control terminal c2.

In this embodiment, the first transistor MI to the thirteenth transistor M13 are all P-type MOS transistors. The control terminal of the PMOS transistor is a gate electrode, the first electrode of the PMOS transistor is a source electrode, and the second electrode of the PMOS transistor is a drain electrode, or the first electrode is a drain electrode and the second electrode is a source electrode. The turn-on level of the PMOS transistor is a low level, and the turn-off level of the PMOS transistor is a high level. In some other embodiments, those skilled in the art can easily conclude that the shift register unit provided by the present disclosure can be easily changed to all N-type MOS transistors. Alternatively, the shift register unit provided by the present disclosure can also be easily changed to a CMOS transistor or the like.

In this embodiment, referring to FIG. 11, the waveform diagram shown in FIG. 11 includes five processes: t21, t22, t23, t24 and t25. During these five processes, the output signal of the signal output terminal Gout of the above-mentioned shift register unit completes a process from setting to resetting. It should be noted that, for convenience of understanding, the high-level signal is represented by “H”, and the low-level signal is represented by “L” in the drawings. The relationship between the input and output of the shift register unit in the above five processes is analyzed below based on the waveform diagram in FIG. 11 and the circuit diagram in FIG. 10.

In this embodiment, referring to FIGS. 11 and 12, during the t21 process, the signal input terminal IN inputs a low level, the first timing control signal line CKV1 inputs a high level, the second timing control signal line CKV2 inputs a high level, and the third timing control signal line CKV3 inputs a low level. At this time, the first transistor T1, the fourth transistor T4, the sixth transistor T6, the seventh transistor T7, the eighth transistor T8, the ninth transistor T9, the tenth transistor T10, the eleventh transistor T11 and the twelfth transistor T12 are turned on, and the second transistor T2, the third transistor T3, the fifth transistor T5 and the thirteenth transistor T13 are turned off. Specifically, the first transistor Tl and the tenth transistor T10 are turned on due to the low potential of the third timing control signal line CKV3. The low potentials of the signal input terminal IN and the second power supply VEE are respectively written into the second node N2 and the first node N1, at the same time, the fourth transistor T4 and the twelfth transistor T12 are turned on due to the low potential of the second node N2. The low potential of the third timing control signal line CKV3 is written into the first node N1, and the high potential is written into the third node N3 due to turn-on of the fourth transistor T4, the fifth transistor T5 is turned off. The first node N1 and the second node N2 are at a low potential, so that both the seventh transistor T7 and the eighth transistor T8 are turned on. Finally, the signal output terminal Gout outputs the high potential of the first power supply VDD and the second timing control signal line CKV2.

In this embodiment, referring to FIGS. 11 and 13, during the t22 process, the signal input terminal IN inputs a high level, the first timing control signal line CKV1 inputs a high level, the second timing control signal line CKV2 inputs a low level, and the third timing control signal line CKV3 inputs a high level. At this time, the fourth transistor T4, the fifth transistor T5, the eighth transistor T8, the ninth transistor T9, the twelfth transistor T12, and the thirteenth transistor T13 are turned on, and the first transistor T1, the second transistor T2, the third transistor T3, the sixth transistor T6, the seventh transistor T7, the tenth transistor T10 and the eleventh transistor T11 are turned off. Specifically, the first transistor T1 is turned off due to the high level of the third timing control signal line CKV3. The second node N2 maintains the low level at the previous moment, the eighth transistor T8 remains turned on. The fourth transistor T4 and the twelfth transistor T12 remain turned on due to the low potential of the second node N2. The low potential of the second timing control signal line CKV2 is written into the third node N3 due to turn-on of the fourth transistor T4, the fifth transistor T5 is turned on. The high potential of the third timing control signal line CKV3 is written into the first node N1 simultaneously by the fifth transistor T5 and the twelfth transistor T12, the seventh transistor T7 is turned off. Finally, the signal output terminal Gout outputs the low potential of the second timing control signal line CKV2.

In this embodiment, referring to FIGS. 11 and 14, during the t23 process, the signal input terminal IN inputs a high level, the first timing control signal line CKV1 inputs a low level, the second timing control signal line CKV2 inputs a high level, and the third timing control signal line CKV3 inputs a high level. At this time, the second transistor T2, the third transistor T3, the sixth transistor T6, the seventh transistor T7, and the ninth transistor T9 are turned on, and the first transistor T1, the fourth transistor T4, the fifth transistor T5, the eighth transistor T8, the tenth transistor T10, the eleventh transistor T11, the twelfth transistor T12, and the thirteenth transistor T13 are turned off. Specifically, the second transistor T2 and the third transistor T3 are turned on due to the low potential of the first timing control signal line CKV1. The high potential of the first power supply VDD is written into the second node N2 due to turn-on of the second transistor T2, the fourth transistor T4, the eighth transistor T8 and the twelfth transistor T12 are turned off. The high potential of the first power supply VDD is written into the third node N3 due to turn-on of the third transistor T3, the fifth transistor T5 is turned off. The first node N1 maintains the low potential at the previous moment, the seventh transistor T7 is turned on. Finally, the signal output terminal Gout outputs the high potential of the first power supply VDD.

In this embodiment, referring to FIGS. 11 and 15, during the t24 process, the signal input terminal IN inputs a high level, the first timing control signal line CKV1 inputs a high level, the second timing control signal line CKV2 inputs a high level, and the third timing control signal line CKV3 inputs a low level. At this time, the first transistor T1, the sixth transistor T6, the seventh transistor T7, the ninth transistor T9, the tenth transistor T10, and the eleventh transistor T11 are turned on, and the second transistor T2, the third transistor T3, and the fourth transistor T4, the fifth transistor T5, the eighth transistor T8, the twelfth transistor T12 and the thirteenth transistor T13 are turned off. Specifically, the first transistor T1, the tenth transistor T10 and the eleventh transistor T11 are turned on due to the low potential of the third timing control signal line CKV3. The high potential of the signal input terminal IN is written into the second node N2, the fourth transistor T4, the eighth transistor T8 and the twelfth transistor T12 remain turned off. The high potential of the first power supply VDD is written into the third node N3 due to turn-on of the eleventh transistor T11, the fifth transistor T5 remains turned off. The low potential of the second power supply VEE is written into the first node N1 due to turn-on of the tenth transistor T11, the seventh transistor T7 remains turned on. Finally, the signal output terminal Gout outputs the high potential of the first power supply VDD.

In this embodiment, referring to FIGS. 11 and 16, during the t25 process, the signal input terminal IN inputs a high level, the first timing control signal line CKV1 inputs a high level, the second timing control signal line CKV2 inputs a low level, and the third timing control signal line CKV3 inputs a high level. At this time, the sixth transistor T6, the seventh transistor T7, the ninth transistor T9, and the thirteenth transistor T13 are turned on, and the first transistor T1, the second transistor T2, the third transistor T3, the fourth transistor T4, and the fifth transistor T5, the eighth transistor T8, the tenth transistor T10, the eleventh transistor T11 and the twelfth transistor T12 are turned off. Specifically, the first transistor T1, the tenth transistor T10 and the eleventh transistor T11 are turned off due to the high potential of the third timing control signal line CKV3. The third node N3 maintains the high potential at the previous moment, the fifth transistor T5 is turned off. At the same time, the first node N1 maintains the low potential at the previous moment, and the high potential of the first power supply VDD is written into the second node N2 due to turn-on of the sixth transistor T6 and the thirteenth transistor T13 which is caused by the low potential of the first node N1 and the second timing control signal line CKV2, the eighth transistor T8 is turned off, and the seventh transistor T7 is turned on due to the low potential of the first node N1. Finally, the signal output terminal Gout outputs the high potential of the first power supply VDD.

The operation steps of the shift register unit after t25 repeat the t23 process to the t25 process until the next frame image begins to display, the start pulse signal STV or the signal input terminal IN inputs a low level, and re-enters the next round of the t21 process.

In this embodiment, the relationship between the input and output of the shift register unit is: if the start pulse signal STV or the signal input terminal IN is at a low level in a certain process, then under the action of the first timing control signal line CKV1, the second timing control signal line CKV2 and the third timing control signal line CKV3, the signal output terminal Gout also outputs a low level in the next process. In other processes, the start pulse signal STV or the signal input terminal IN and the signal output terminal Gout all remain at a high level, until the start pulse signal STV or the signal input terminal IN inputs a low level again, and the signal output terminal Gout outputs a low level again. It is equivalent to that the shift register unit conducts delay processing on the low-level signal from the start pulse signal STV or the signal input terminal IN and then output it from the signal output terminal Gout.

Based on the same inventive concept, an embodiment of the present disclosure also provides a display device, including the above-mentioned display panel 10 provided by the embodiment of the present disclosure. The display device can be: a mobile phone, a tablet computer, a television, a monitor, a notebook computer, a digital photo frame, a navigator, or any other product or component having a display function. For the implementation of the display device, reference may be made to the embodiment of the display panel 10 described above, and repeated details will not be described again.

In summary, the gate drive circuit and display panel of the present disclosure improve the output stability of the shift register unit and reduce the number of components of the shift register unit by providing a new 12T3C or 13T3C shift register unit circuit, thereby reducing the bezel width of the display panel, which adapts to the trend of narrow bezel of the display panel.

The above content is a further detailed description of the present disclosure in combination with specific preferable embodiments, and it cannot be concluded that the specific implementation of the present disclosure is limited to these descriptions. For those of ordinary skill in the technical field to which the present disclosure belongs, several simple deductions or substitutions can be made without departing from the concept of the present disclosure, and all of them should be regarded as belonging to the protection scope of the present disclosure.

1. A gate drive circuit, comprising a plurality of stages of shift register units, wherein each shift register unit comprises a control module, a reset module and an output setting module;
wherein the control module comprises:
a third transistor, comprising a first electrode connected to a first power supply, a second electrode connected to a third node, and a gate electrode connected to a first timing control terminal;
a fourth transistor, comprising a first electrode connected to the third node, a second electrode connected to a second timing control terminal, and a gate electrode connected to a fourth node;
a fifth transistor, comprising a first electrode connected to a third timing control terminal, a second electrode connected to a first node, and a gate electrode connected to the third node;
an eleventh transistor, comprising a first electrode connected to the first power supply, a second electrode connected to the third node, and a gate electrode connected to a third timing control terminal;
wherein the reset module comprises:
a second transistor, comprising a first electrode connected to the first power supply, a second electrode connected to the fourth node, and a gate electrode connected to the first timing control terminal;
a tenth transistor, comprising a first electrode connected to the first node, a second electrode connected to a second power supply, and a gate electrode connected to the third timing control terminal;
a twelfth transistor, comprising a first electrode connected to the third timing control terminal, a second electrode connected to the first node, and a gate electrode connected to the fourth node;
wherein the output setting module comprises:
a first transistor, comprising a first electrode connected to the fourth node, a second electrode connected to a signal input terminal, and a gate electrode connected to the third timing control terminal;
a seventh transistor, comprising a first electrode connected to the first power supply, a second electrode connected to a signal output terminal, and a gate electrode connected to the first node;
an eighth transistor, comprising a first electrode connected to the signal output terminal, a second electrode connected to the second timing control terminal, and a gate electrode connected to the second node;
a ninth transistor, comprising a first electrode connected to the fourth node, a second electrode connected to the second node, and a gate electrode connected to the second power supply;
wherein the shift register unit further comprises:
a first capacitor, comprising a first electrode connected to the first power supply, and a second electrode connected to the first node;
a second capacitor, comprising a first electrode connected to the second node, and a second electrode connected to the signal output terminal;
a third capacitor, comprising a first electrode connected to the first power supply, and a second electrode connected to the third node.

2. The gate drive circuit according to claim 1, wherein the reset module further comprises:
a sixth transistor, comprising a first electrode connected to the first node, a second electrode connected to the second power supply, and a gate electrode connected to the first timing control terminal.

3. The gate drive circuit according to claim 1, wherein the reset module further comprises:
a sixth transistor, comprising a second electrode connected to the second node, and a gate electrode connected to the first node;
a thirteenth transistor, comprising a first electrode connected to the first power supply, a second electrode connected to a first electrode of the sixth transistor, and a gate electrode connected to the second timing control terminal.

4. The gate drive circuit according to claim further comprising a timing controller, wherein the timing controller comprises a first timing control signal line, a second timing control signal line and a third timing control signal line.

5. The gate drive circuit according to claim 4, wherein the first timing control signal line is configured to output a first timing control signal, the second timing control signal line is configured to output a second timing control signal, and the third timing control signal line is configured to output a third timing control signal.

6. The gate drive circuit according to claim 5, wherein the shift register unit is configured to conduct delay processing on a signal received from the signal input terminal under control of the first timing control signal, the second timing control signal and the third timing control signal, and the processed signal is output by the signal output terminal.

7. The gate drive circuit according to claim 2, wherein the shift register unit of a previous stage outputs a scan signal to the shift register unit of a next stage, and the shift register unit of a last stage outputs a scan signal.

8. The gate drive circuit according to claim 4, wherein in a (3N−2)-th stage shift register unit, the first timing control terminal is connected to the first timing control signal line, the second timing control terminal is connected to the second timing control signal line, and the third timing control terminal is connected to the third timing control signal line, where N is a positive integer.

9. The gate drive circuit according to claim 8, wherein in a (3N−1)-th stage shift register unit, the first timing control terminal is connected to the third timing control signal line, the second timing control terminal is connected to the first timing control signal line, and the third timing control terminal is connected to the second timing control signal line, where N is a positive integer.

10. The gate drive circuit of claim 9, wherein in a 3N-th stage shift register unit, the first timing control terminal is connected to the second timing control signal line, the second timing control terminal is connected to the third timing control signal line, and the third timing control terminal is connected to the first timing control signal line, where N is a positive integer.

11. The gate drive circuit according to claim 3, wherein the first to thirteenth transistors are all P-type MOS transistors.

12. A display panel, comprising a gate drive circuit, wherein the gate drive circuit comprises a plurality of stages of shift register units, each shift register unit comprises a control module, a reset module and an output setting module:
wherein the control module comprises:
a third transistor, comprising a first electrode connected to a first power supply, a second electrode connected to a third node, and a gate electrode connected to a first timing control terminal:
a fourth transistor, comprising a first electrode connected to the third node, a second electrode connected to a second timing control terminal, and a gate electrode connected to a fourth node;
a fifth transistor, comprising a first electrode connected to a third timing control terminal, a second electrode connected to a first node, and a gate electrode connected to the third node;
an eleventh transistor, comprising a first electrode connected to the first power supply, a second electrode connected to the third node, and a gate electrode connected to a third timing control terminal;
wherein the reset module comprises:
a second transistor, comprising a first electrode connected to the first power supply, a second electrode connected to the fourth node, and a gate electrode connected to the first timing control terminal;
a tenth transistor, comprising a first electrode connected to the first node, a second electrode connected to a second power supply, and a gate electrode connected to the third timing control terminal;
a twelfth transistor, comprising a first electrode connected to the third timing control terminal, a second electrode connected to the first node, and a gate electrode connected to the fourth node;
wherein the output setting module comprises:
a first transistor, comprising a first electrode connected to the fourth node, a second electrode connected to a signal input terminal, and a gate electrode connected to the third timing control terminal;
a seventh transistor, comprising a first electrode connected to the first power supply, a second electrode connected to a signal output terminal, and a gate electrode connected to the first node;
an eighth transistor, comprising a first electrode connected to the signal output terminal, a second electrode connected to the second timing control terminal, and a gate electrode connected to the second node;
a ninth transistor, comprising a first electrode connected to the fourth node, a second electrode connected to the second node, and a gate electrode connected to the second power supply;
wherein the shift register unit further comprises:
a first capacitor, comprising a first electrode connected to the first power supply, and a second electrode connected to the first node:
a second capacitor, comprising a first electrode connected to the second node, and a second electrode connected to the signal output terminal;
a third capacitor, comprising a first electrode connected to the first power supply, and a second electrode connected to the third node.

13. The display panel according to claim 12, wherein the reset module further comprises:
a sixth transistor, comprising a first electrode connected to the first node, a second electrode connected to the second power supply, and a gate electrode connected to the first timing control terminal.

14. The display panel according to claim 12, wherein the reset module further comprises:
a sixth transistor, comprising a second electrode connected to the second node, and a gate electrode connected to the first node;
a thirteenth transistor, comprising a first electrode connected to the first power supply, a second electrode connected to a first electrode of the sixth transistor, and a gate electrode connected to the second timing control terminal.

15. The display panel according to claim 13, further comprising a timing controller, wherein the timing controller comprises a first timing control signal line, a second timing control signal line and a third timing control signal line.

16. The display panel according to claim 15, wherein the first timing control signal line is configured to output a first timing control signal, the second timing control signal line is configured to output a second timing control signal, and the third timing control signal line is configured to output a third timing control signal.

17. The display panel according to claim 16, wherein the shift register unit is configured to conduct delay processing on a signal received from the signal input terminal under control of the first timing control signal, the second timing control signal and the third timing control signal, and the processed signal is output by the signal output terminal.

18. The display panel according to claim 13, wherein the shift register unit of a previous stage outputs a scan signal to the shift register unit of a next stage, and the shift register unit of a last stage outputs a scan signal.

19. The display panel according to claim 15, wherein in a (3N−2)-th stage shift register unit, the first timing control terminal is connected to the first timing control signal line, the second timing control terminal is connected to the second timing control signal line, and the third timing control terminal is connected to the third timing control signal line, where N is a positive integer.

20. The display panel according to claim 19, wherein in a (3N−1)-th stage shift register unit, the first timing control terminal is connected to the third timing control signal line, the second timing control terminal is connected to the first timing control signal line, and the third timing control terminal is connected to the second timing control signal line, where N is a positive integer.
